(19) United States
(12) Patent Application Publication
(10) Pub. No.: US 2006/0271751 A1
(43) Pub. Date: Nov. 30, 2006

(54) Convolutional interleaver/de-interleaver

(75) Inventors: Inching Chen, Portland, OR (US); Kyle McCanta, Beaverton, OR (US)

Correspondence Address: VENABLE LLP, P.O. BOX 34385, WASHINGTON, DC, 20043-9998, US

(73) Assignee: Intel Corporation, Santa Clara, CA (US)

(21) Appl. No.: 11/135,493

(22) Filed: May 24, 2005

(51) Int. Cl. G06F 13/28

(52) U.S. Cl. 711/157

(57) ABSTRACT

Interleaving/de-interleaving may be performed by transferring multi-byte data blocks to be interleaved or de-interleaved into a set of memory banks on a column-by-column basis, transferring the data blocks to a data memory on a row-by-row basis, transferring the data blocks back to the memory banks on a row-by-row basis, using a set of shifted addresses that may cause cyclic shifting of the row orders, and transferring the interleaved or de-interleaved data blocks out of the memory banks on a column-by-column basis. The roles of rows and columns may, equivalently, be reversed.

### BACKGROUND OF THE INVENTION

Wireless communications has become more and more common. Today, there are a multitude of wireless devices, including personal digital assistants (PDAs), cellular telephones, and personal computers with wireless network connectivity. In the wireless communications world, as well as in other noisy communications channels, it is common to use error-control coding often in combination with interleaving, to combat the effects of noise and other channel effects.

One consideration when developing coding/interleaving is speed. The systems that perform the encoding, interleaving, decoding, and de-interleaving may slow down the communication process.

A second consideration, particularly in small, autonomous communication devices (for example, but not limited to, PDAs, cellular telephones, etc.) is power. Such devices are often powered by batteries, which are finite power sources. Furthermore, power consumption when devices are running but idle may contribute to power drainage.

### BRIEF DESCRIPTION OF THE DRAWINGS

Various embodiments of the invention will now be described in connection with the associated drawings, in which:

FIG. 1 depicts a conceptual block diagram of a system according to an exemplary embodiment of the invention;

FIG. 2 depicts a conceptual block diagram of an apparatus that may be used to implement an exemplary embodiment of the invention;

FIG. 3 depicts a conceptual block diagram of a sub-system that may form part of exemplary embodiments of the invention;

FIGS. 4A and 4B depict logical and physical storage, respectively, of data according to exemplary embodiments of the invention;

FIG. 5 depicts a method of operation according to exemplary embodiments of the invention; and

FIG. 6 depicts an exemplary embodiment of a system that may be used to implement at least a portion of embodiments of the invention.

### DETAILED DESCRIPTION OF EMBODIMENTS OF THE INVENTION

In the following description, numerous specific details are set forth. However, it is understood that embodiments of the invention may be practiced without these specific details. In other instances, well-known circuits, structures, and/or techniques have not been shown in detail in order not to obscure an understanding of this description.

References to “one embodiment”, “an embodiment”, “example embodiment”, “various embodiments”, etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

According to some embodiments of the invention, an algorithm may be considered to be a self-consistent sequence of acts or operations leading to a desired result. These may include physical manipulations of physical quantities. Usually, though not necessarily, these quantities may take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities, as applicable, and are merely convenient labels applied to these quantities.

According to some embodiments discussed below, terms such as “processing,” “computing,” “calculating,” “determining,” or the like, may refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, in some embodiments, the term “processor” may refer to any device or portion of a device that processes electronic data from registers and/or memory to transform that electronic data into other electronic data that may be stored in registers and/or memory. A “computing platform” may, in some embodiments, comprise one or more processors.

Some embodiments of the present invention may include apparatuses for performing the operations herein. An apparatus may be specially constructed for the desired purposes, or it may comprise a general purpose device selectively activated or reconfigured by a program stored in the device.

Some embodiments of the invention may be implemented in one or a combination of hardware, firmware, and software. Embodiments of the invention may also be implemented as instructions stored on a machine-accessible medium, which may be read and executed by a computing platform to perform the operations described herein. A machine-accessible medium may include any mechanism for storing or transmitting information in a form readable by a machine (e.g., a computer). For example, a machine-accessible medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

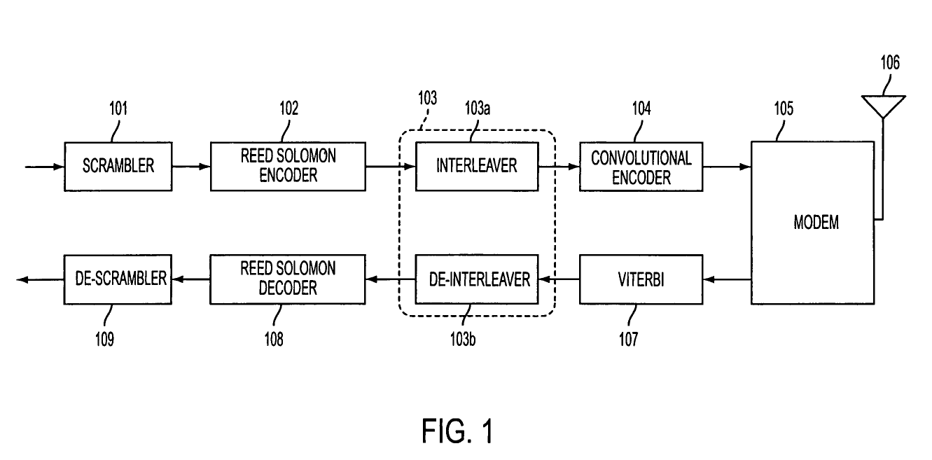

FIG. 1 shows a system according to an exemplary embodiment of the invention. In particular, FIG. 1 shows a block diagram of a transmit/receive system that may be used in, for example, but which is not limited to, wireless communications. Such a system may include a scrambler 101 that may scramble digital data prior to transmission. This may be followed by a first error-control encoder 102, shown here as Reed-Solomon encoder; however, the invention is not to be limited to such an encoder, and other codes may be used. This first layer of error-control coding may be followed by interleaving, which may be performed by interleaver 103a. In some embodiments, interleaver 103a may be followed by a second layer of error-control coding, which may, for example, be carried out using a convolutional encoder 104, but which is not to be thusly limited. Encoder 104 may be followed by a modem 105, which may be coupled to an antenna 106. Modem 105 may be used to modulate outgoing encoded data and may be used to demodulate incoming signals. The modulated signals from modem 105 may be transmitted via antenna 106, and incoming signal may be picked up by antenna 106 and may be passed to modem 105. Antenna 106 may be any type of antenna useful in the particular communication environment in which the system may be being used, and may include, but is not limited to, a monopole antenna, a dipole antenna, a strip-type antenna, or a phased-array antenna.

In the receive direction, the system may include a decoder 107, which may correspond to encoder 104, and which may be, for example, a Viterbi decoder or other type of convolutional decoder, including, but not limited to, a sequential decoder or a feedback decoder; however, decoder 107 is also not limited to a convolutional decoder, but may be any appropriate decoder. This decoder 107 may be followed by a de-interleaver 103b. De-interleaver 103b may be followed by a decoder 108, that may correspond to encoder 102, and which may be, but is not limited to, a Reed-Solomon decoder. Finally, decoder 108 may be followed by a descrambler 109.

As shown in FIG. 1, interleaver 103a and de-interleaver 103b may be combined into a single interleaver/de-interleaver apparatus 103. This may be used, for example, in a case in which the interleaver 103a and de-interleaver 103b are designed such that they may share hardware components, for example, but not limited to, use for half-duplex operation. In an alternative arrangement, interleaver/de-interleaver apparatus 103 may include separate hardware components to implement interleaver 103a and de-interleaver 103b, which may be useful, for example, in the case of full-duplex communication. A further possibility may be to include multiple apparatuses within interleaver/de-interleaver 103, for example, to support parallel communication channels.

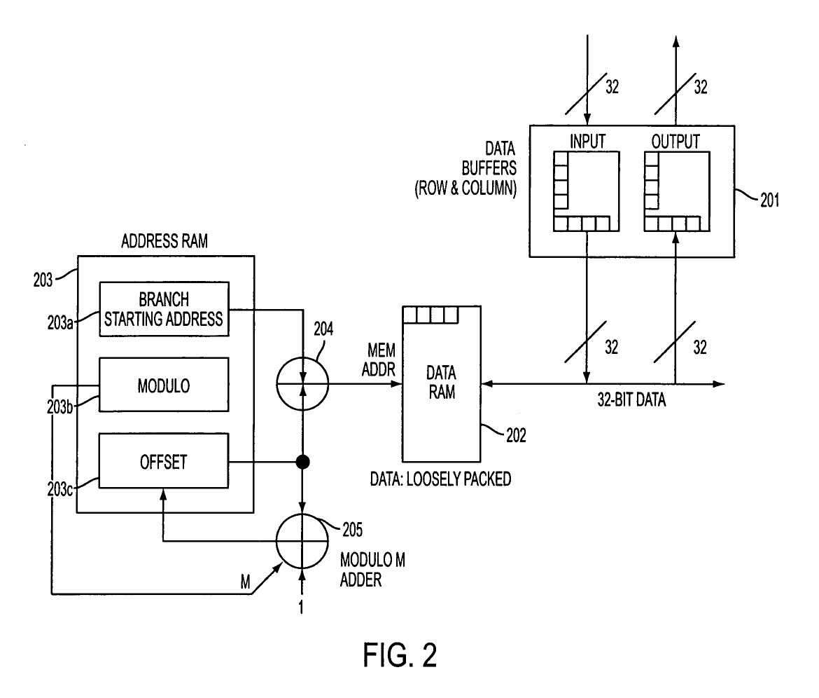

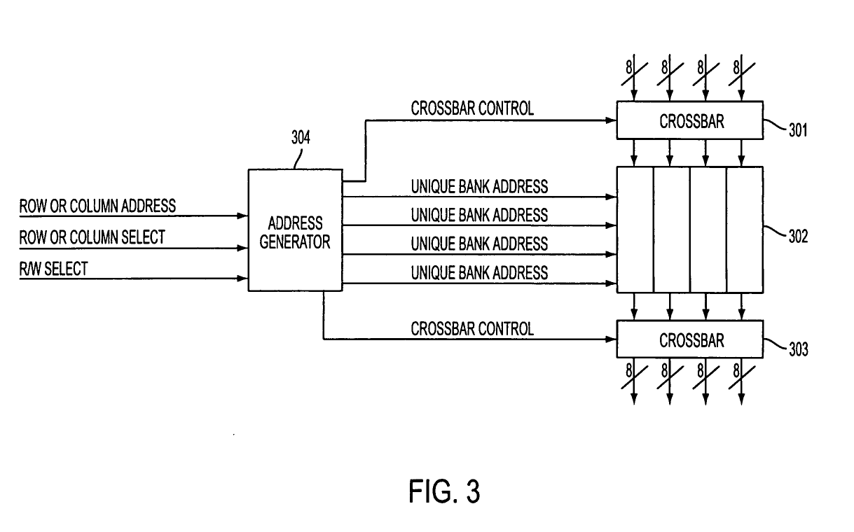

FIG. 2 shows a conceptual block diagram of an interleaver/de-interleaver apparatus according to some embodiments of the invention. The apparatus of FIG. 2 may be used to accomplish the various relative data shifting operations that may be used in the operations of interleaving and de-interleaving data. The apparatus of FIG. 2 may include data buffers 201. In some embodiments of the invention, data buffers 201 may comprise a series of data banks. Data buffers 201 may also be implemented with separate input and output buffers or as a single buffer shared between input and output. In many applications, interleaving may be performed on a multiple-byte-wise basis, and the exemplary embodiment of FIG. 2 may reflect such a scenario, which may facilitate parallelism. This is reflected in the four-byte (32-bit) connections to and from data buffers 201; however, the invention is not to be thus limited. A specific exemplary embodiment of the data buffers 201 will be discussed below in conjunction with FIG. 3.

Data buffers 201 may be coupled to a data RAM 202. Data RAM 202 may comprise semiconductor RAM or any other functionally equivalent storage unit. In some embodiments of the invention, a loose-packing scheme may be used to store data in data RAM 202. This may result in certain simplifications in the apparatus as will be discussed further below.

Finally, the apparatus may comprise address generation components, here shown as a memory unit, such as address RAM 203, modulo M adder 205, and concatenation device 204. The invention, however, need not be limited to this structure. Furthermore, the address RAM 203 may take the form of any functionally equivalent storage unit.

The address generation components 203-205 in FIG. 2 may provide a simplified address generation scheme in conjunction with loose-packing of data RAM 202. By “loose-packing,” it is meant that there may be gaps left between memory locations in which data is stored. In particular, by storing data using a loose-packing scheme, it may permit the memory addresses used to be chosen so that each of them may be formed by concatenating a fixed set of bits, branch starting address 203a, with a variable set of offset bits 203c, which may be formed by the use of modulo M adder 205, where M is set by modulo unit 203b. That is, loose-packing may permit a convenient selection of memory addresses, such that these addresses may be generated in a simplified fashion. M may be chosen according to the delay associated with a particular branch of the convolutional interleaver/de-interleaver. The term “branch” may refer to a branch of a conventional structure corresponding to a convolutional interleaver/de-interleaver, i.e., using multiple branches having different numbers of delay units (e.g., for a conventional structure using four-byte units, for example, a first branch may have zero delay, a second branch may have a delay of four bytes, a third branch may have a delay of eight bytes, etc.). Note that the address generation components may alternatively be implemented in software and/or firmware, as well as in hardware, as shown.

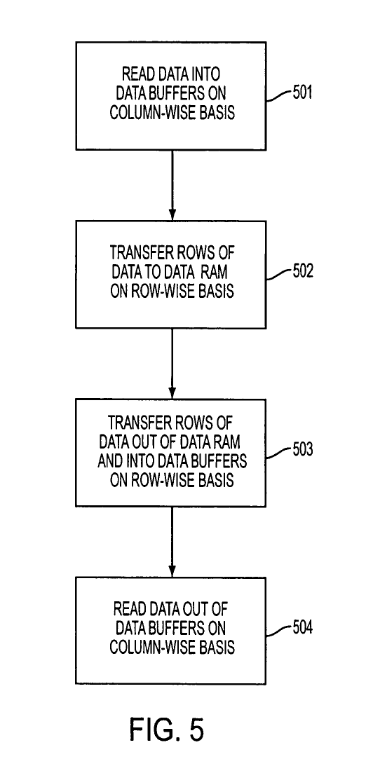

The apparatus of FIG. 2 may operate according to the data transfer process shown in FIG. 5, which may be explained as follows. Data to be interleaved may be read into data buffers 201, as shown in block 501. In the particular exemplary implementation shown in FIG. 2, this may be in units of four bytes (32 bits), but the invention is not to be thus limited. In general, the amount of data read into data buffers 201 may correspond to the number of bytes per unit (for example, but not limited to, four) times the number of branches (i.e., in the conventional implementation of the interleaver/de-interleaver, as discussed above). In an exemplary implementation, to which the invention is not limited, there may be fifty-two branches, using units of four bytes, for a total of 208 bytes. Data may be read into data buffers 201 on a column-wise basis 501. The data may then be read out of data buffers 201 on a row-wise basis (in the particular exemplary embodiment of FIG. 2, this is in four-byte units) and may be stored in a row-wise fashion in data RAM 202, as described in block 502, with the addresses being obtained from address generation components 203-205.

In an interleaving or de-interleaving operation, various portions of the data may be shifted by various amounts, relative to each other. In various embodiments of the invention, this may correspond to circular shifting, where data shifted out of one end of a block may be fed into the other end of the same memory block. This shifting may be accomplished by offsetting the addresses used to read the data back out of data RAM 202, where the offsetting may be performed by the address generation components 203-205. The shifted data may thus be obtained by reading the data from data RAM 202 using the offset addresses 503. This shifted data may then be written back into data buffers 201 on a row-wise basis 503 and may be read out of data buffers 201, in interleaved form, on a column-wise basis 504.

FIG. 3 depicts an exemplary embodiment of data buffers 201 according to some embodiments of the invention. Data buffers 201 may comprise crossbar switches 301 and 303, each of which may be coupled to memory banks 302. The memory banks may be coupled to an address generator 304.

The apparatus of FIG. 3 may be operated as follows. Address generator 304 may be instructed, via input signals, as to whether a column or row should be written into or read out of memory banks 302 and as to which row or column should be written into or read from. Address generator 304 may generate unique bank addresses that specify the particular memory locations in memory banks 302 where the desired data may be written or read. Crossbar switches 301 and 303 may be used to select and/or route the data as directed by the unique bank addresses and depending upon data is being transferred within components of the apparatus of FIG. 2 (which may use crossbar switch 303) or out of the apparatus of FIG. 2 (which may use crossbar switch 301). Control signals for the particular crossbar switch being used, 301 or 303, may be generated by address generator 304.

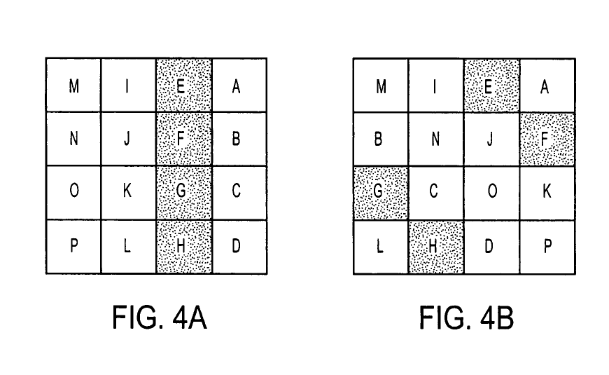

FIGS. 4A and 4B reflect storage of data in memory banks 302, according to some exemplary embodiments of the invention. In such exemplary embodiments, a skewed storage scheme may be utilized. This is particularly useful in the case of memory banks 302 in which only a single memory location may be addressed at a given time. In such a case, a skewed storage scheme permits the reading out of multiple associated memory units (e.g., bytes) at the same time. The exemplary embodiment shown in FIGS. 4A and 4B depicts four rows and four columns of bytes, but the invention is not limited to this scenario and, rather, may be generalized to other numbers of rows/columns and other units of data. FIG. 4A shows how, logically, one may wish to read data into memory banks 302, i.e., on a column-wise basis. In FIG. 4A, for example, the right-most column may receive the first four bytes, A-D, the next column may receive the next four bytes, E-H, and so on. However, if the data were to be written in this fashion, one may not be able to access all four bytes, e.g., E-H, at the same time. Therefore, using crossbar switch 301, the data may be written into memory banks 302 as shown in FIG. 4B. In this skewed storage scheme, the first row, in this exemplary embodiment, is shown in FIG. 4B as being the same as in FIG. 4A, while the second, third, and fourth rows of FIG. 4B are shown, in this exemplary embodiment, as having been circularly shifted by one, two, and three bytes, respectively, with respect to their counterpart rows in FIG. 4A. The shaded boxes show how, in this exemplary embodiment, bytes E-H of FIG. 4A may be shifted relative to each other in FIG. 4B. In FIG. 4B, each of bytes E-H may be located in a different column (memory bank), thus allowing all four bytes to be read out simultaneously.

While the above discussion may focus on embodiments of the invention that use data columns in some roles and data rows in other roles, it would be apparent to a skilled artisan that these roles may be reversed. For example, the roles of rows and columns in data buffers 201 may be reversed, and the roles of rows and columns in data RAM 202 may be reversed. This may involve associated changes in address generation.

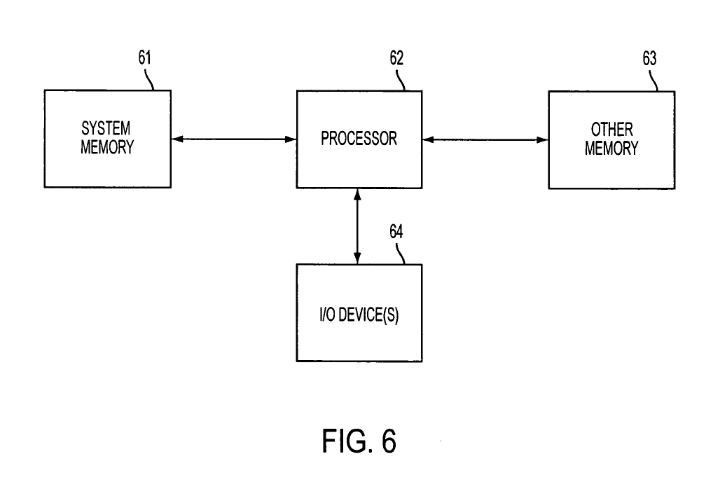

Some embodiments of the invention, as discussed above, may be embodied, at least in part, in the form of software instructions on a machine-accessible medium. Such an embodiment may be illustrated in FIG. 6. The computer system of FIG. 6 may include at least one processor 62, with associated system memory 61, which may store, for example, operating system software and the like. The system may further include other additional memory 63, which may, for example, include software instructions to perform various applications. System memory 61 and other memory 63 may comprise separate memory devices, a single shared memory device, or a combination of separate and shared memory devices. The system may also include one or more input/output (I/O) devices 64, for example (but not limited to), keyboard, mouse, trackball, printer, display, network connection, etc. The present invention, or parts thereof, may be embodied as software instructions that may be stored in system memory 61 or in other memory 63. Such software instructions may also be stored in removable or remote media (for example, but not limited to, compact disks, floppy disks, etc.), which may be read through an I/O device 64 (for example, but not limited to, a floppy disk drive). Furthermore, the software instructions may also be transmitted to the computer system via an I/O device 64, for example, a network connection; in such a case, a signal containing the software instructions may be considered to be a machine-accessible medium. The system of FIG. 6 may be coupled to various hardware components shown in FIG. 2 and/or in FIG. 3.

The invention has been described in detail with respect to various embodiments, and it will now be apparent from the foregoing to those skilled in the art that changes and modifications may be made without departing from the invention in its broader aspects. The invention, therefore, as defined in the appended claims, is intended to cover all such changes and modifications as fall within the true spirit of the invention.

What is claimed is:

1. An apparatus comprising:
a data buffer unit to receive input data and to provide output data, said input and output data comprising multi-byte input and output data blocks, respectively, the output data blocks to be output in a final order different from an order in which the input data blocks were received;
a data memory unit coupled to said data buffer unit to receive said input data blocks from said data buffer unit in a first intermediate order different from said order in which said input data blocks were received and to store said data blocks in said first intermediate order; and
an address generation unit to provide addresses for reading data blocks out of said data memory unit in a second intermediate order, said data blocks in said second intermediate order to be written into said data buffer unit in said second intermediate order and to be read out of said data buffer unit in said final order, said final order being different from said second intermediate order.

2. The apparatus according to claim 1, wherein said address generation unit comprises:
a memory unit;
a concatenation unit coupled to said memory unit; and
a modulo adder coupled to said memory unit.

3. The apparatus according to claim 1, wherein said data buffer unit comprises:
a multiplicity of data banks;
at least one crossbar switch coupled to said multiplicity of data banks; and
an address generator coupled to said multiplicity of data banks.

4. The apparatus according to claim 3, wherein said at least one crossbar switch comprises:
a first crossbar switch coupled to said multiplicity of data banks to provide said input data blocks to said multiplicity of data banks and to receive said output data blocks from said multiplicity of data banks; and
a second crossbar switch coupled between said multiplicity of data banks and said data memory unit.

5. The apparatus according to claim 1, further comprising:
a second data buffer unit to receive second input data blocks and to provide second output data blocks, said second output data blocks to be output in a second final order different from an order in which said second input data blocks were received;
a second data memory unit coupled to said second data buffer unit to receive said second input data blocks from said second data buffer unit in a second first intermediate order different from said order in which said second input data blocks were received and to store said data blocks in said second first intermediate order;
a second address generation unit to provide addresses for reading data blocks out of said second data memory unit in a second second intermediate order, said data blocks in said second second intermediate order to be written into said second data buffer unit in said second second intermediate order and to be read out of said second data buffer unit in said second final order, said second final order being different from said second second intermediate order.

6. A system comprising:
a data buffer unit to receive input data and to provide output data, said input and output data comprising multi-byte input and output data blocks, respectively, the output data blocks to be output in a final order different from an order in which the input data blocks were received;
a data memory unit coupled to said data buffer unit to receive said input data blocks from said data buffer unit in a first intermediate order different from said order in which said input data blocks were received and to store said data blocks in said first intermediate order; and
an address generation unit to provide addresses for reading data blocks out of said data memory unit in a second intermediate order, said data blocks in said second intermediate order to be written into said data buffer unit in said second intermediate order and to be read out of said data buffer unit in said final order, said final order being different from said second intermediate order; and
an antenna coupled to said data buffer unit to facilitate one or more of the group consisting of the following: providing said input data and receiving said output data.

7. The system according to claim 6, further comprising:
a first device selected from the group consisting of: a first error-control encoder coupled to provide said input data to said data buffer unit and a first error-control decoder coupled to provide said input data to said data buffer unit.

8. The system according to claim 7, further comprising:
a second device selected from the group consisting of: a second error-control encoder coupled to receive said output data from said data buffer unit and a second error-control decoder coupled to receive said output data from said data buffer unit.

9. The system according to claim 7, further comprising:
a second data buffer unit to receive second input data blocks and to provide second output data blocks, said second output data blocks to be output in a second final order different from an order in which said second input data blocks were received;
a second data memory unit coupled to said second data buffer unit to receive said second input data blocks from said second data buffer unit in a second first intermediate order different from said order in which said second input data blocks were received and to store said data blocks in said second first intermediate order;
a second address generation unit to provide addresses for reading data blocks out of said second data memory unit in a second second intermediate order, said data blocks in said second second intermediate order to be written into said second data buffer unit in said second second intermediate order and to be read out of said second data buffer unit in said second final order, said second final order being different from said second second intermediate order; and
a second device selected from the group consisting of: a second error-control encoder coupled to provide said input data to said second data buffer unit and a second error-control decoder coupled to provide said input data to said second data buffer unit.

10. The system according to claim 6, further comprising:
a modem coupled between said data buffer unit and said antenna.

11. A method comprising:
writing multi-byte data blocks into a multiplicity of data buffers on a first basis selected from the group consisting of: column-by-column basis and row-by-row basis;
transferring said data blocks from said data buffers to a data memory unit on a second basis, where said second basis is row-by-row if said first basis is column-by-column and said second basis is column-by-column if said first basis is row-by-row;
transferring data blocks out of said data memory unit on said second basis and into said data buffers on said second basis, wherein said transferring data blocks out of said data memory unit uses a different order for at least one row, where said second basis is row-by-row, or for at least one column, where said second basis is column-by-column, from an order in which said data blocks were transferred into said at least one row or column, respectively, of said data memory unit; and
reading data blocks out of said data buffers on said first basis.

12. The method according to claim 1 1, wherein said transferring data blocks out of said data memory unit comprises:
generating at least one address; and
providing said at least one address to said data memory unit to provide said different order.

13. The method according to claim 12, wherein said generating comprises:
concatenating a branch starting address with an offset to form said at least one address.

14. The method according to claim 13, wherein said generating comprises:
incrementing said offset, modulo a selected number, to provide a next offset; and
using said next offset to create a next address.

15. The method according to claim 11, wherein said transferring said data from said data buffers to a data memory unit comprises:
using a loose-packing scheme to store said data in said data memory unit.

16. The method according to claim 11, wherein said writing data blocks on said first basis and said reading data blocks on said first basis are performed using a skewed storage scheme.

17. A machine-accessible medium that provides instructions that, when executed by a computing platform, cause said computing platform to perform operations comprising:
writing multi-byte data blocks into a multiplicity of data buffers on a first basis selected from the group consisting of: column-by-column basis and row-by-row basis;
transferring said data blocks from said data buffers to a data memory unit on a second basis, where said second basis is row-by-row if said first basis is column-by-column and said second basis is column-by-column if said first basis is row-by-row;
transferring data blocks out of said data memory unit on said second basis and into said data buffers on said second basis, wherein said transferring data blocks out of said data memory unit uses a different order for at least one row, where said second basis is row-by-row, or for at least one column, where said second basis is column-by-column, from an order in which said data blocks were transferred into said at least one row or column, respectively, of said data memory unit; and
reading data blocks out of said data buffers on said first basis.

18. The machine-accessible medium according to claim 17, wherein said transferring data blocks out of said data memory unit comprises:
generating at least one address; and
providing said at least one address to said data memory unit to provide said different order.

19. The machine-accessible medium according to claim 18, wherein said generating comprises:
concatenating a branch starting address with an offset to form said at least one address.

20. The machine-accessible medium according to claim 17, wherein said generating comprises:
incrementing said offset, modulo a selected number, to provide a next offset; and
using said next offset to create a next address.
